(19) United States
(12) Patent Application Publication
(10) Pub. No.: US 2007/0057972 A1
(43) Pub. Date: Mar. 15, 2007

(54) Method and apparatus for blending colors

(75) Inventor: Aleksey Krasnopolsky, Kiryat-Gat (IL)

Correspondence Address: Martin D. MOYNIHAN;PRTSI, Inc., P.O. Box 16446, Arlington, VA, 22215, US

(73) Assignee: Samsung Electronics Co., Ltd.

(21) Appl. No.: 11/501,717

(22) Filed: Aug. 10, 2006

Related U.S. Application Data
(60) Provisional application No. 60/715,184, filed on Sep. 9, 2005.

(51) Int. Cl. G09G 5/00

(52) U.S. Cl. 345/629

(57) ABSTRACT

A method for blending two colors, where the colors are blended according to a blending factor, is performed as follows. First, a first factor and a second factor, represented in binary form, are determined. A sequence of binary operations, preferably consisting of a sequence of shift and masking operations, are then performed. The binary operations are performed upon a first color and upon a second color. The colors preferably utilize a packing scheme for separately specifying several color components in a single frame. The binary operations performed upon the colors serve to obtain descending fractions of each of the colors. The descending fractions of the first color are multiplied by corresponding bits of the first factor. These multiplied fractions are then summed together to obtain the first product (equaling the product of the first color by the first factor). The second product is obtained similarly, utilizing the descending fractions of the second color and the second factor. The blended color is then calculated by summing the first product and the second product. The blended color is thus a blend of the two original colors in the proportions specified by the blending factor.

### RELATED APPLICATIONS

This application claims the benefit of U.S. Provisional Application No. 60/715,184, filed on Sep. 9, 2005, which is incorporated herein in its entirety by reference.

### FIELD AND BACKGROUND OF THE INVENTION

The present invention relates to color blending to achieve transparency effects, and, more particularly but not exclusively, to color blending techniques suitable for mobile telephone applications.

In modern three-dimensional (3D) graphics applications, semi-transparent objects are often used for special effects and for the realistic presentation of virtual objects. In order to render an object semitransparent, the object's color is blended with the color of underlying objects.

In a technique known as alpha blending, the proportions of the blend are denoted by an Alpha value. Alpha is the level of transparency of the object and ranges from 0 (fully transparent) to 1 (fully opaque). The colors are separately blended for each pixel of the object being rendered, according to the formula:
Result_color=Alpha*New_color+(1−Alpha)*Old_color (1)

In color images, the color of each pixel is often specified by the RGB color model in which the intensity level of each of the colors red, green and blue is specified separately. When the three colors are packed into a single frame, the alpha blending algorithm must be tailored to perform the multiplication operations for each color in the frame. A typical solution is to extract each color from the frame, calculate the resultant color separately for each color channel, and then repack the three resultant color values into a single frame. An example of this approach for a 5-6-5 packing structure is presented below.

In the 5-6-5 packing structure, the color of a pixel is specified by the three colors, Red, Green, Blue, compacted into a 16 bit frame buffer entry, as:
Color=R|G|B
The five most significant bits indicate the Red intensity value, the following six bits indicate the Green intensity value, and the last five bits indicate the Blue intensity value.

If we denote the bits as:
R=r4 r3 r2 r1 r0
G=g5 g4 g3 g2 g1 g0
B=b4 b3 b2 b1 b0

The color word bits consist of:
r4 r3 r2 r1 r0 g5 g4 g3 g2 g1 g0 b4 b3 b2 b1 b0
where r0 . . . r4 are the R color bits, g0 . . . g5 are the G color bits, and b0 . . . b4 are the B color bits.

In order to blend the colors, the colors are first separated by performing three bitwise operations. These bitwise operations involve shifting the frame by a suitable amount, and then extracting the appropriate bits to obtain a single color, as illustrated below.
R=color>>11
G=(color>>5) & 0x3f
B=color & 0x1f
where “>>X” indicates a right-shift operation by X bits, “&” indicates an AND operation, and “0xH” is the 16-bit binary representation of the hexadecimal number H. Specifically:

$$Red \text{:} \begin{matrix}r 4 & r 3 & r 2 & r 1 & r 0 & g 5 & g 4 & g 3 & g 2 & g 1 & g 0 & b 4 & b 3 & b 2 & b 1 & b 0 & >> & 11 = & & \\ 0 & 0 & 0 & 0 & 0 & 0 & 0 & 0 & 0 & 0 & 0 & r 4 & r 3 & r 2 & r 1 & r 0 & & & & \end{matrix} \\$$

$$Green \text{:} \begin{matrix} r 4 & r 3 & r 2 & r 1 & r 0 & g 5 & g 4 & g 3 & g 2 & g 1 & g 0 & b 4 & b 3 & b 2 & b 1 & b 0 & >> & 5 = \\ = 0 & 0 & 0 & 0 & 0 & r 4 & r 3 & r 2 & r 1 & r 0 & g 5 & g 4 & g 3 & g 2 & g 1 & g 0 & & \end{matrix} \\$$

$$\begin{matrix} 0 & 0 & 0 & 0 & 0 & r 4 & r 3 & r 2 & r 1 & r 0 & g 5 & g 4 & g 3 & g 2 & g 1 & g 0 & \& & 0 x 3 f = & \\ = 0 & 0 & 0 & 0 & 0 & r 4 & r 3 & r 2 & r 1 & r 0 & g 5 & g 4 & g 3 & g 2 & g 1 & g 0 & \& & & \\ 0 & 0 & 0 & 0 & 0 & 0 & 0 & 0 & 0 & 0 & 0 & 1 & 1 & 1 & 1 & 1 & 1 & & \\ 0 & 0 & 0 & 0 & 0 & 0 & 0 & 0 & 0 & 0 & 0 & 0 & g 5 & g 4 & g 3 & g 2 & g 1 & g 0 & \end{matrix} \\$$

$$Blue : \begin{matrix}= r 4 & r 3 & r 2 & r 1 & r 0 & g 5 & g 4 & g 3 & g 2 & g 1 & g 0 & b 4 & b 3 & b 2 & b 1 & b 0 & \& & 0 x 1 f = \\ = r 4 & r 3 & r 2 & r 1 & r 0 & g 5 & g 4 & g 3 & g 2 & g 1 & g 0 & b 4 & b 3 & b 2 & b 1 & b 0 & \& & \\ 0 & 0 & 0 & 0 & 0 & 0 & 0 & 0 & 0 & 0 & 0 & 0 & 1 & 1 & 1 & 1 & 1 & \\ = 0 & 0 & 0 & 0 & 0 & 0 & 0 & 0 & 0 & 0 & 0 & 0 & 0 & b 4 & b 3 & b 2 & b 1 & b 0\end{matrix} \\$$

The above calculations are performed twice, once for the new color and once for underlying pixel color.

In the next stage, the R, G and B channels are blended separately:
R_result=Alpha*R_new+(1−Alpha)*R_old
G_result=Alpha*G_new+(1−Alpha)*G_old (2)
B_result=Alpha*B_new+(1−Alpha)*B_old

This calculation involves 6 multiplications for a single pixel.

Finally, the resultant R G and B components are assembled back into a frame:
Result_color=(R<<11)+(G<<5)+B

Note, that the above solution is appropriate only if all the multiplications are performed in floating point, which is very time-consuming for mobile devices processors with no hardware floating point support. The algorithm could be adopted for fixed-point operations, but in this case even more bitwise operations are required.

Per-pixel calculations are often the bottleneck of software rendering systems. This is particularly true for mobile devices such as cell phones, which typically have low CPU performance and no hardware acceleration. Since the 3D object to be rendered can easily exceed the mobile telephone screen dimensions, the number of blended pixels can be close to screen size, involving a total of 320*240 calculations for typical screen dimensions. Thus, even a small optimization of a per-pixel operation may yield a big improvement in overall performance of the application.

There is thus a widely recognized need for, and it would be highly advantageous to have, a method and apparatus for color blending devoid of the above limitations.

### SUMMARY OF THE INVENTION

According to a first aspect of the present invention there is provided a method for blending two colors which includes the following steps. A first factor and a second factor, respectively associated with a first and a second color, are determined. The first and second factors are represented in binary format. A sequence of shift and masking operations are then performed upon the first color to obtain descending fractions of the first color. The descending fractions of the first color are multiplied by a corresponding bit of the first factor, and the multiplied fractions are summed together to obtain a product of the first color by the first factor. A sequence of shift and masking operations are performed upon the second color to obtain descending fractions of the second color. The descending fractions of the second color are multiplied by a corresponding bit of the second factor, and the multiplied fractions are summed together to obtain a product of the second color by the second factor. The blended color is then calculated by summing together the product of the first color by the first factor and the product of the second color by the second factor.

According to a second aspect of the present invention there is provided a method for blending two colors which includes the following steps. A first color, a second color, a first factor and a second factor are each represented in binary format. The first factor is utilized to define a first sequence of binary logic operations, and the second factor is utilized to define a second sequence of binary logic operations. The first sequence is performed upon the first color to obtain a product of the first color by the first factor. The second sequence is performed upon the second color to obtain a product of the second color by the second factor. The blended color is calculated as the sum of the product of the first color by the first factor and the product of the second color by the second factor.

According to a third aspect of the present invention there is provided an apparatus for blending colors, for blending a first and a second color according to a blending factor. The apparatus includes a factor formatter, a fraction obtainer, a multiplier and a combiner. The factor formatter provides a factor in binary format. The fraction obtainer performs a sequence of shift and masking operations upon a color to obtain descending fractions of the color. The multiplier, which is associated with the blending factor provider and the fraction obtainer, multiplies the descending fractions of the color by the corresponding bit of an associated factor, and sums the multiplied fractions together to provide a product of the color by the associated factor. The combiner, which is associated with the multiplier, calculates a blended color as a sum of the product of the first color by the first factor and the product of the second color by the second factor.

According to a fourth aspect of the present invention there is provided a computer-readable storage medium containing a set of instructions for blending a first and a second color according to a blending factor. The set of instructions includes a factor formatting routine, a fraction obtaining routine, a multiplier routine, and a combiner routine. The factor formatting routine provides a first factor and a second factor in binary format. The fraction obtaining routine performs a sequence of shift and masking operations upon a color to obtain descending fractions of the color. The multiplier routine multiplies the descending fractions of a color by a corresponding bit of an associated factor, and sums the multiplied fractions together to obtain a product of the color by the associated factor. The combiner routine calculates a blended color as the sum of the product of the first color by the first factor and the product of the second color by the second factor.

The present invention successfully addresses the shortcomings of the presently known configurations by providing a method and apparatus which can perform color blending by performing binary operations, such as shift and masking, and without processing-intensive multiplications.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified flowchart of a method for blending two colors, according to a first preferred embodiment of the present invention;

FIG. 2 is a simplified flowchart of a method for blending two colors, according to a second preferred embodiment of the present invention; and

FIG. 3 is a simplified block diagram of an apparatus for blending colors, according to a preferred embodiment of the present invention.

### DESCRIPTION OF THE PREFERRED EMBODIMENTS

The present embodiments teach a method for blending two colors according to a specified blending factor, without requiring complex multiplication operations. Specifically, the present embodiments teach representing the blending factor by a binary number having a limited bit length, and utilizing the binary blending factor to guide a sequence of binary logic operations. These binary logic operations, performed in proper sequence, can effectively multiply a color by the blending factor without requiring a fixed-point or floating-point multiplication.

The preferred embodiments described below are particularly suitable for mobile devices with limited color resolution, and for other applications which require only a limited number of transparency levels. The blending factor can be then be expressed by a limited number of discrete values, instead of a large range of floating point values.

An additional benefit of the present embodiments is that there is no need to unpack a color frame into its color components prior to multiplication by the blending factor. The sequence of logic operations may be performed only once per color, rather than for each component separately.

The principles and operation of a method for blending colors according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In the following, the terms “blending factor” “alpha” and “alpha factor” are used interchangeably.

In order to more clearly describe the preferred embodiments, a non-limiting example of the method described below is now presented. The present example is for 16-bit packed color (RGB 5-6-5), but can easily be adapted to any color packing scheme.

The present example provides seventeen levels of transparency, which is expected to give satisfactory performance for most mobile device applications. In fact, seventeen transparency levels can produce an animal fur effect on a mobile device display.

The calculations performed on the R channel are now described. Assume that we have the following values available:
R4=R
R3=R/2
R2=R/4 (3)
R1=R/8
R0=R/16
Further assume that we want to calculate the value Alpha*R, where Alpha (the blending factor) ranges from 0 to 1 by steps of 1/16 (i.e. seventeen discrete levels). Notice, that Alpha can be rewritten in the following way:
Alpha=i4*16/16+i3*8/16+i2*4/16+i1*2/16+i0*1/16

where each i value is either 0 or 1.

Now we can express Alpha*R as:

$$Alpha * R = ( i 4 * 16 / 16 + i 3 * 8 / 16 + i 2 * 4 / 16 + i 1 * 2 / 16 + i 0 * 1 / 16 ) * R == i 4 * R * 16 / 16 + i 3 * R * 8 / 16 + i 2 * R * 4 / 16 + i 1 * R * 2 / 16 + i 0 * R * 1 / 16 == i 4 * R 4 + i 3 * R 3 + i 2 * R 2 + i 1 * R 1 + i 0 * R 0 \qquad ( 4 )$$

To obtain a maximal value of Eqn. 4 equal to R, the i values are set to (i4=1, i3=0, i2=0, i1=0, i0=0). To obtain a minimal value of Eqn. 4 equal to zero, the i values are set to (i4=0, i3=0, i2=0, i1=0, i0=0).

If we treat the i values as bits, we obtain I=(i4 i3 i2 i1 i0), where i4 is most significant bit, and I ranges from 0 to 16. I represents the transparency levels for R, where 16 is fully opaque and 0 is fully transparent. Note that using a five-bit value for I, it is possible to express values from 0 to 31. In the present case only seventeen values are used rather than the entire range of five-bit values, in order to have the resultant blended R component in the range of R to 0.

Although Eqn. 4 requires five multiplications, these multiplications are by zero or one only, and therefore performed during one CPU cycle. The net effect of these multiplications is to sum together only those fractions of R needed to provide the required level of transparency.

It is now shown that these calculations may be performed simultaneously for R, G and B channels by performing the shift and masking operations on the packed RGB frame, with no need to separate the channels.

The color word (i.e. frame) consists of bits arranged as
(r4 r3 r2 r1 r0|g5 g4 g3 g2 g1 g0|b4 b3 b2 b1 b0)

Right shifting the word gives:
(0 r4 r3 r2 r1|r0 g5 g4 g3 g2 g1|g0 b4 b3 b2 b1)

Now the following mask is applied to remove redundant bits which have shifted into wrong color space:
0 1 1 1 1|0 1 1 1 1 1|0 1 1 1 1
to obtain:
(0 r4 r3 r2 r1|0 g5 g4 g3 g2 g1|0 b4 b3 b2 b1)
which is (R/2|G/2|B/2) which we will denote Color/2. Repeating the above sequence of shift and masking operations four times with the appropriate masks, we obtain:
color=R|G|B
color/2=R/2|G/2|B/2
color/4=R/4|G/4|B/4
color/8=R/8|G/8|B/8
color/16=R/16|G/16|B/16

The above operations are performed on both the old color and the new color, without unpacking either color.

Next binary representations are provided for both Alpha and 1−Alpha, and denoted I and J respectively:
I=Alpha=(i4 i3 i2 i1 i0)
J=16−I=(j4 j3 j2 j1 j0) (5)

The resulting color can now be calculated:

$$Resulting \_color = Alpha * New\_color + ( 1 - Alpha ) * Old\_color = i 4 * New\_color + i 3 * New\_color / 2 + i 2 * New\_color / 4 + \\ i 1 * New\_color / 8 + i 0 * New\_color / 16 + j 4 * Old\_color + j 3 * Old\_color / 2 + \\ j 2 * Old\_color / 4 + j 1 * Old\_color / 8 + j 0 * Old\_color / 16$$

The above calculation does not require any floating-point operations, and can therefore be performed during one CPU cycle.

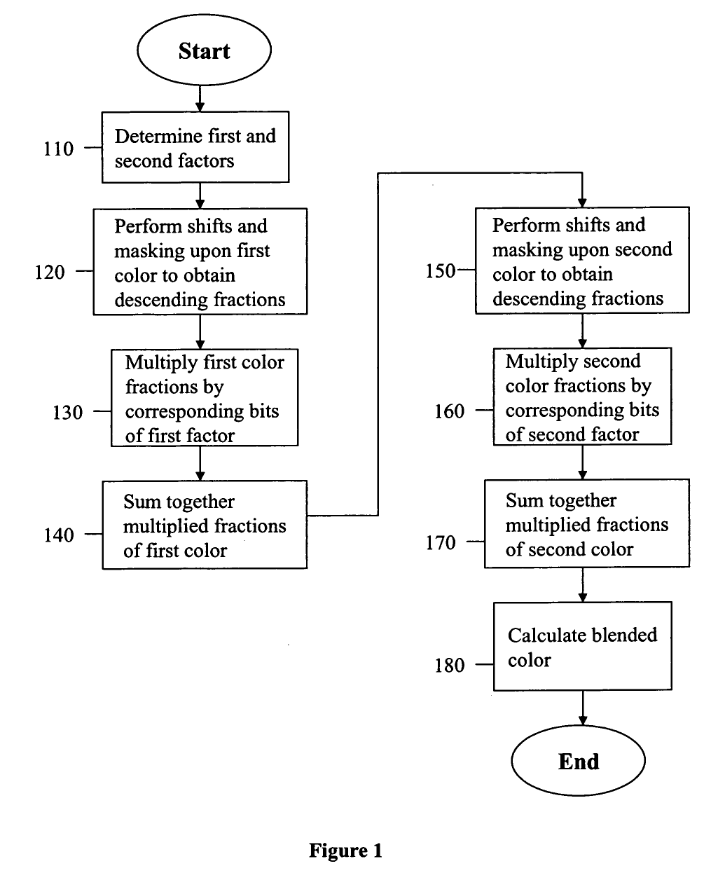

Reference is now made to FIG. 1, which is a simplified flowchart of a method for blending two colors, according to a first preferred embodiment of the present invention. In the preferred embodiment, the colors are blended according to the alpha-blending formula (see Eqn. 1).

In step 110, the binary forms of two blending factors (denoted herein the first factor and the second factor) are determined. The first factor serves to multiply the first color (for example the old color) and the second factor serves to multiply the second color (for example the new color). These binary representations will later serve as multiplicative factors for the Color/2, Color/4, etc. fractions of the first and second colors respectively.

Preferably the two factors are derived from a single specified blending factor. In the preferred embodiment, the specified blending factor is the Alpha value, in which case the first factor is the binary representation of Alpha and the second factor is the binary representation of (1−Alpha). Alpha may be expressed as a value ranging from zero to one, as a discrete level (for example an integer from zero to seventeen), directly in binary format, or in any other suitable representation. Preferably, an Alpha value of one is represented as a 1 in the MSB, followed by 0's in all subsequent bits.

In step 120, a sequence of shift and masking operations are performed upon the first color to obtain descending fractions of the first color. The term “descending fractions” denotes a sequence of partial values of the color, such as Color/2, Color/4, etc. . . . , which can be summed together to form the necessary transparency levels.

Assuming the binary representations of the colors follow the convention of having the MSB as the left-most bit, these operations entail right-shifting the first color by the appropriate number of bits (i.e. one bit to obtain R/2), and then masking any bits that have moved into portions of the word allocated to a different color. Preferably, this masking operation is performed by ANDing the color frame with a binary word having zeros in all masked locations and ones in all non-masked locations.

In a first preferred embodiment, the fraction is obtained directly from an initial color. The initial color is shifted by the appropriate number of bits (e.g. two bits for Color/4) and then a masking scheme is applied to set an equal number of most significant bits of each of the color components to zero (e.g. the two leftmost bits of each component).

In a second preferred embodiment, a given fraction is obtained from the preceding fraction. The preceding fraction is shifted by a single bit, and then the most significant bit of each of the color components is set to zero.

In step 130, the descending fractions of the first color are multiplied by the corresponding bit of the first factor. The multiplied fractions are then summed together in step 140 to obtain a product of the first color by the first factor Alpha*First_color (denoted herein the first product).

In steps 150 to 170, an equivalent set of operations is performed on the second color using the second factor. The result is the product of the second color by the second factor (1−Alpha)*Second_color (denoted herein the second product).

In step 180, the blended color is calculated by summing the first and second products.

Note that the order in which the steps are performed may vary. For example the binary representation of the two factors (step 110) may be determined either before or after the descending fractions of one or both colors are obtained (steps 120 and 130).

In the preferred embodiment, the first and second colors are provided in a packing scheme, such as 5-6-5 RGB, where the level of each color component is specified separately in a different portion of the frame. When a packing scheme is utilized, the shift and masking operations are preferably performed upon a packed representation of color.

Preferably, the bit length of each of the two factors does not exceed the number of bits representing any one of the colors or color components. (In the above-described example a 5-6-5 packing scheme is utilized, and the factors I and J each have five bits, yielding seventeen transparency levels.) It is then possible to use a direct correspondence between the position of the bit and a color fraction.

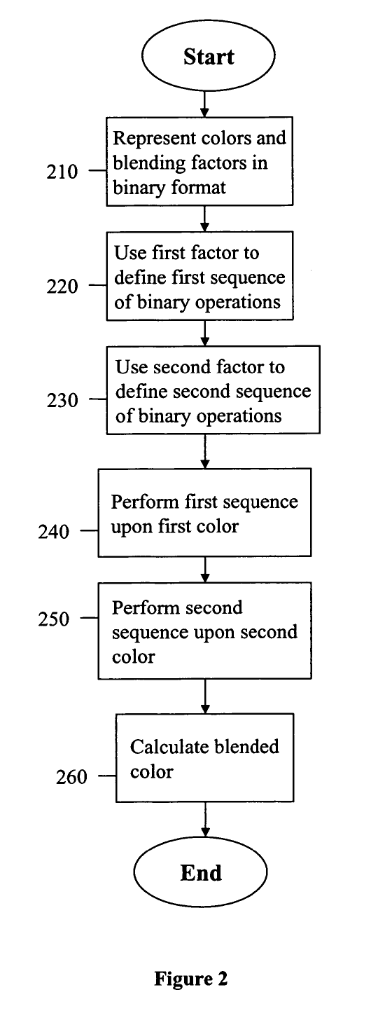

Reference is now made to FIG. 2, which is a simplified flowchart of a method for blending two colors, according to a second preferred embodiment of the present invention. The present embodiment uses the blending factor to define sequences of binary logic operations, such as shift and AND operations, which are performed on the initial color values in order to blend the colors in the required proportions.

In step 210, the colors to be blended, and their respective factors are represented in binary format. The first and second factors may be provided independently, or they may be derived from a single provided value such as Alpha (where the second factor is derived as 1−Alpha).

In step 220, the first factor is utilized to define a sequence of binary logic operations. The sequence is defined such that when the operations are performed upon a given color, the result is the product of the given color by the first factor. The sequence of operations may thus be tailored to a specific value of the blending factor. For example, it may not be necessary to calculate all the fractions of a given color, but only those fractions for which the corresponding bit equals 1.

In step 230, the second factor is utilized to define a sequence of binary logic operations. The sequence is defined such that when the operations are performed upon a given color, the result is the product of the given color by the second factor (the second product).

In step 240, the first sequence of binary operations is performed upon the first color to obtain the first product.

In step 250, the second sequence of binary operations is performed upon the second color to obtain the second product.

In step 260, the blended color is calculated by summing together the first product and the second product.

Preferably, the colors are provided in packed format, and the binary logic operations are performed upon the packed frame.

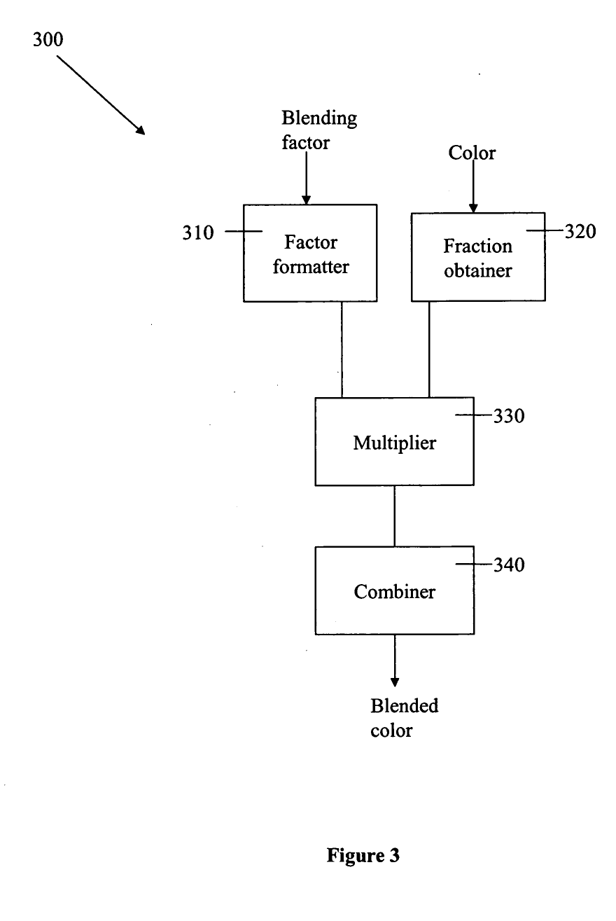

Reference is now made to FIG. 3, which is a simplified block diagram of an apparatus for blending colors, according to a preferred embodiment of the present invention. Apparatus 300 blends two colors according to a specified blending factor. Factor formatter 310 provides a factor in binary format. Fraction obtainer 320 performs a sequence of shift and masking operations upon a color to obtain descending fractions of the color. Multiplier 330 multiplies each of the descending fractions of a color by a corresponding bit of an associated factor, and sums the multiplied fractions together in order to provide a product of the color by the associated factor. Combiner 340 calculates a blended color by summing together the products of two or more colors, where each color is multiplied by an associated factor.

In a further preferred embodiment, a computer-readable storage medium contains a set of instructions for blending colors according to a blending factor. The set of instructions includes a factor formatting routine, a fraction obtaining routine, a multiplier routine and a combiner routine. The factor formatting routine provides a first factor and a second factor in binary format. The fraction obtaining routine performs a sequence of shift and masking operations upon a color to obtain descending fractions of the color. The multiplier routine multiplies the descending fractions of a color by a corresponding bit of an associated factor, and sums the multiplied fractions together to obtain a product of the color by the associated factor. The combiner routine calculates a blended color as a sum of a product of the first color by the first factor and a product of the second color by the second factor.

The above-described embodiments may be generalized to a case in which more than two colors are blended together. One or more blending factors may be used to indicate the required proportions for each one of the colors.

The importance of the graphical capabilities of mobile devices, such as cellular telephones, continues to increase. The color blending techniques described above provide transparency and other screen blending effects without requiring heavy processing tasks such as floating point multiplications. Mobile devices with advanced graphical-capabilities may thus be offered to consumers, without requiring the inclusion of expensive hardware acceleration components.

It is expected that during the life of this patent many relevant mobile devices, blending techniques, and color packing and representation formats will be developed and the scope of the corresponding terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for blending two colors, comprising:
determining a first factor and a second factor respectively associated with a first and a second color, said first and second factors being represented in binary format;
performing a sequence of shift and masking operations upon said first color to obtain descending fractions of said first color;
multiplying said descending fractions of said first color by a corresponding bit of said first factor, and summing said multiplied fractions together to obtain a product of said first color by said first factor;
performing a sequence of shift and masking operations upon said second color to obtain descending fractions of said second color;
multiplying said descending fractions of said second color by a corresponding bit of said second factor, and summing said multiplied fractions together to obtain a product of said second color by said second factor; and
calculating a blended color as a sum of said product of said first color by said first factor and said product of said second color by said second factor.

2. A method according to claim 1, further comprising deriving said first and second factors from a specified blending factor.

3. A method according to claim 2, wherein said deriving comprises setting said first factor equal to said blending factor and setting said second factor equal to unity minus said blending factor.

4. A method according to claim 1, wherein the bit length of each one of said first factor and said second factor is no greater than the bit length of each one of said colors.

5. A method according to claim 1, wherein said first and second colors are provided according to a packing scheme separately specifying a respective level of multiple color components.

6. A method according to claim 5, wherein said shift and masking operations are performed upon a packed representation of a color, such that a resultant fraction of said color comprises a packed frame separately specifying a corresponding fraction of said color components.

7. A method according to claim 5, wherein the bit length of each one of said first factor and said second factor is no greater than the bit length of each one of said color components.

8. A method according to claim 1, wherein said performing a sequence of shift and masking operations upon a color comprises obtaining a subsequent fraction of said color from a preceding fraction.

9. A method according to claim 8, wherein said first and second colors are provided according to a packing scheme separately specifying a respective level of multiple color components, and wherein said obtaining comprises:
shifting said preceding fraction by a single bit; and
setting a single most significant bit (MSB) of said packed color components equal to zero.

10. A method according to claim 1, wherein said performing a sequence of shift and masking operations upon a color comprises obtaining a fraction directly from an initial color.

11. A method according to claim 10, wherein said first and second colors are provided according to a packing scheme separately specifying a respective level of multiple color components, and wherein said obtaining comprises:
shifting said color by a specified number of bits; and
setting an equal number of most significant bits of said packed color components equal to zero.

12. A method according to claim 1, wherein said first factor and said second factor each range over a set of discrete levels.

13. A method according to claim 1, wherein a maximum permitted value of said first factor and of said second factor has an MSB equal to one, followed by zeros in the subsequent bits.

14. A method according to claim 1, wherein a range of said blending factor is from zero to one.

15. A method for blending two colors, comprising:
representing a first color, a second color, a first factor and a second factor in binary format;
utilizing said first factor to define a first sequence of binary logic operations;
utilizing said second factor to define a second sequence of binary logic operations;
performing said first sequence upon said first color to obtain a product of said first color by said first factor;
performing said second sequence upon said second color to obtain a product of said second color by said second factor; and
calculating a blended color as a sum of said product of said first color by said first factor and said product of said second color by said second factor.

16. A method according to claim 15, wherein said first and second colors are provided according to a packing scheme separately specifying a respective level of multiple color components.

17. A method according to claim 16, wherein said binary logic operations are performed upon a packed representation of a color, such that a product of a color comprises a packed frame separately specifying a corresponding product of said color components.

18. An apparatus for blending colors, for blending a first and a second color according to a blending factor, comprising:
a factor formatter, configured for providing a factor in binary format;
a fraction obtainer, configured for performing a sequence of shift and masking operations upon a color to obtain descending fractions of said color;
a multiplier, associated with said blending factor provider and said fraction obtainer, configured for multiplying said descending fractions of a color by a corresponding bit of an associated factor, and summing said multiplied fractions together to provide a product of said color by said associated factor; and
a combiner, associated with said multiplier, configured for calculating a blended color as a sum of a product of a first color by a first factor and a product of a second color by a second factor.

19. An apparatus according to claim 18, wherein said factor formatter is further operable to determine said first factor and said second factor from a specified blending factor.

20. An apparatus according to claim 18, wherein said first and second colors are provided according to a packing scheme separately specifying a respective level of multiple color components.

21. An apparatus according to claim 20, wherein said binary logic operations are performed upon a packed representation of a color, such that a product of a color comprises a packed frame separately specifying a corresponding product of said color components.

22. A computer-readable storage medium containing a set of instructions for blending a first and a second color according to a blending factor, the set of instructions comprising:
a factor formatting routine, for providing a first factor and a second factor in binary format;
a fraction obtaining routine, for performing a sequence of shift and masking operations upon a color to obtain descending fractions of said color;
a multiplier routine, for multiplying said descending fractions of a color by a corresponding bit of an associated factor, and summing said multiplied fractions together to obtain a product of said color by said associated factor; and
a combiner routine, for calculating a blended color as a sum of a product of said first color by said first factor and a product of said second color by said second factor.
